(19) United States
(12) Patent Application Publication
(10) Pub. No.: US 2010/0332183 A1
(43) Pub. Date: Dec. 30, 2010

(54) DYE-DOPED NANOPARTICLES, A METHOD OF MANUFACTURE OF THE SAME, AND A METHOD OF DETERMINING A PERCENTAGE WEIGHT OF A DYE WHICH YIELDS A REQUIRED RELATIVE FLUORESCENT INTENSITY FROM A DYE-DOPED NANOPARTICLE

(76) Inventors: Robert Nooney, Norwich Norfolk (IE); Ondrej Stranik, Prague (CZ)

Correspondence Address: WINSTEAD PC, P.O. BOX 50784, DALLAS, TX, 75201, US

(21) Appl. No.: 12/863,120

(22) PCT Filed: Jan. 19, 2009
(86) PCT No.: PCT/EP09/50570

§ 371 Date: Aug. 23, 2010

Related U.S. Application Data
(60) Provisional application No. 61/021,760, filed on Jan. 17, 2008.

(51) Int. Cl. G01N 21/64; C09K 11/06; G01G 9/00

(52) U.S. Cl. 702/173; 252/301.16; 250/459.1; 977/773

(57) ABSTRACT

The invention provides dye-doped nanoparticles comprising silica doped with molecules of a near infra red dye comprising 4,5-Benzo-1′-ethyl-3,3,3′,3′-tetramethyl-1-(4-sulfobutyl)indodicarbocyanin-5′-acetic acid N-succinimidyl ester, and dye-doped nanoparticles derivatised with a functional group. The invention further provides a method of manufacture of dye-doped nanoparticles comprising the steps of preparing a dye mixture by dissolving a dye in the surfactant hexanol and conjugating the dye with an organosilane, forming a microemulsion of water droplets in oil, adding the dye mixture to the microemulsion, and adding a source of silicon and a catalyst to the microemulsion, which causes growth of silica nanoparticles in the water droplets of the microemulsion which silica nanoparticles are doped with the dye. The invention further provides, in a dye-doped nanoparticle, a method of determining a % weight of the dye which yields a required relative fluorescent intensity from the nanoparticle.

Fluorescent spectroscopy is an excellent sensing method for biological diagnostics. The most commonly used fluorescent labels are organic or inorganic molecules containing π conjugated ring structures. There are a large number of commercial dyes available with absorption bands across the visible and near infra red (NIR) wavelengths which are used routinely for optical bioassays. Moreover, their small size and short lifetimes enable excellent spatial and temporal resolution. However, organic and inorganic dyes are susceptible to rapid photobleaching and quenching due to interaction with the solvent environment and molecular quenchers such as oxygen.

There is a great deal of work on the development of second generation labels, such as quantum dots and dye-doped silica nanoparticles (NPs). Silica matrices provide a stable environment resistant to both chemical attack and mechanical stress. Non porous silica matrices also provide a protective barrier isolating the dye from molecular quenchers thus improving quantum efficiency. Silica surfaces can also be functionalised with bioreactive groups using conventional organosilane chemistry. As well as these important features, the main motivation for using NIRNPs as labels in bioassays is the potential for vast improvements in assay performance, for example higher sensitivity and lower level of detection (LOD), resulting from the orders of magnitude increase in brightness of the NP label compared to that of the single dye label.

There are two methods for the preparation of monodispersed silica NPs; the Stöber method and the inverse micelle method. The Stöber method uses an ammonium hydroxide catalyst in ethanol and water to control the hydrolysis and condensation rates of alkoxysilanes. In general, the Stöber method produces monodispersed silica NPs greater than 100 nm in diameter. Recently, a modification of the Stöber method was developed at Cornell University, whereby monodispersed dye doped silica NPs were synthesised down to 15 nm in diameter. These NPs, called C-dots, have brightness levels approaching those of quantum dots and for certain dyes the rate of photobleaching is reduced by an order of magnitude. With regard to the inverse micelle method, NPs are synthesised inside surfactant stabilised water droplets dispersed in a non polar solvent. It is relatively easy to prepare monodispersed NPs in diameters from several microns down to 15 nm reproducibly. The diameter is dependent on the concentration of catalyst, water, alkoxysilane and type of surfactant used. Hydrophilic organometallic dyes such as tris (2,2′-bipyridyl)dichlororuthenium (II) hexahydrate (Ru(bpy)₃) have been incorporated into these silica NPs with loadings up to 20 wt %. These NPs are significantly brighter than free dyes and exhibit no observable photobleaching. In a direct binding assay for the detection of hIgG antibody, silica NPs were approximately 50 times more sensitive than quantum dots under the same conditions. Organometallic dye-doped silica NPs have also been used in immunocytochemistry, immunohistochemistry and DNA/protein microarray detection. It is also possible to dope silica NPs with organic dyes that are not soluble inside the water droplet by conjugating them to dextran. Alternatively the dye can be conjugated to an organosilane whereupon partial hydrolysis of the silane group increases the solubility significantly. Moreover the dye is covalently linked to the silica network and does not leach out over time.

NIR dyes offer several advantages over other organic dyes that fluoresce at shorter wavelengths, such as fluorescein or rhodamine red. In common with other work on organic dyes, we classify a NIR dye as a dye having a fluorescence excitation maximum greater than 650 nm. At NIR wavelengths there is low background interference from the fluorescence of biological molecules, solvents and substrates. Furthermore, whole blood has very weak absorption in the NIR region, reducing the need for whole blood filtering. NIR light can also penetrate skin and tissue to several millimetres making possible fluorescence detection in dermatological or non-invasive diagnostic devices. The main disadvantage of incorporating NIR organic dyes into NPs is self-quenching of fluorescence via Homo-Forster Resonance Energy Transfer (HFRET). This effect occurs when dye molecules with small Stokes shifts (as is the case with most NIR dyes) are in close proximity.

The invention seeks to address at least some of the issues referred to above.

According to a first aspect of the invention there is provided one or more dye-doped nanoparticles comprising silica doped with molecules of a near infra red dye comprising 4,5-Benzo-1′-ethyl-3,3,3′,3′-tetramethyl-1-(4-sulfobutyl)indodicarbocyanin-5′-acetic acid N-succinimidyl ester.

The dye-doped nanoparticles may comprise a silica matrix with the dye molecules dispersed therein. The dye molecules may be substantially homogeneously dispersed in the silica matrix of the nanoparticles. The dye molecules may be stable against leaching out of the nanoparticles over a period of several months. The dye molecules preferably do not photobleach under exposure to light having a wavelength equal to the excitation wavelength of the dye.

The dye-doped nanoparticles may be substantially amorphous. The dye-doped nanoparticles may be microporous.

The dye-doped nanoparticles may be monodispersed.

The dye-doped nanoparticles may form a colloidal suspension. This may be stable for several months against aggregation.

The dye-doped nanoparticles may comprise approximately 1 wt % of the dye molecules.

Preferably, the dye-doped nanoparticles are substantially spherical. The dye-doped nanoparticles may comprise an average diameter of approximately 80 nm+/−5 nm.

The dye-doped nanoparticles may have a brightness which is approximately two or more orders of magnitude brighter than a single dye molecule, for example Cy5 dye.

At least some of the dye molecules may be conjugated to an organosilane, such as aminopropyltriethoxysilane. This may increase covalent attachment of the dye molecules to the silica matrix.

According to a second aspect of the invention there is provided a dye-doped nanoparticle according to the first aspect of the invention which is derivatised with a functional group.

The functional group may be a protein, e.g. an antibody. The functional group may be a nucleic acid e.g. an oligonucleotide.

A protein may be attached to a dye-doped nanoparticle of the invention by first functionalising the nanoparticle with an amine group. The amine group can then react to a protein using a cross linker, such as glutaraldehyde, or succinimidyl 4-[maleimidomethyl]cyclohexane-1-carboxylate.

According to a third aspect of the invention there is provided a method of manufacture of dye-doped nanoparticles comprising the steps of
preparing a dye mixture by dissolving a dye in the surfactant hexanol and conjugating the dye with an organosilane,
forming a microemulsion of water droplets in oil,
adding the dye mixture to the microemulsion, and
adding a source of silicon and a catalyst to the microemulsion, which causes growth of silica nanoparticles in the water droplets of the microemulsion which silica nanoparticles are doped with the dye.

It has been found that adding the dye mixture to the microemulsion prior to adding the source of silicon thereto, promotes homogeneity of dye incorporation into the silica nanoparticles. In addition, it has been found that the nanoparticles cannot be functionalised unless the dye mixture is added to the microemulsion before the source of silicon.

The dye may comprise a near infra red dye comprising 4,5-Benzo-1′-ethyl-3,3,3′,3′-tetramethyl-1-(4-sulfobutyl)indodicarbocyanin-5′-acetic acid N-succinimidyl ester. The dye may be conjugated with an organosilane comprising aminopropyltriethoxysilane (APTES).

The microemulsion of water droplets in oil may be formed by mixing oil, such as cyclohexane oil, and one or more surfactants, such as n-hexanol and Triton® X-100, and adding deionised water thereto.

The source of silicon may comprise tetraethylorthosilica (TEOS). The catalyst may comprise NH₄OH.

The silica nanoparticles may be doped with the dye by attachment of dye/organosilane conjugate of the dye mixture to the silica nanoparticles. This may take place via the sol-gel process. When the dye is conjugated with the organosilane APTES, a triethoxysilane group of the APTES may attach to the silica nanoparticles via the sol-gel process.

The method may further comprise the step of adding a further source of silicon to the microemulsion. The source of silicon may comprise TEOS.

The method may further comprise the step of addition of an anti-aggregating organosilane to the microemulsion. The anti-aggregating organosilane may comprise 3-(trihydroxysilyl)propyl methyl phosphonate, monosodium salt solution (THPMP).

The method may further comprise the step of derivatising the dye-doped nanoparticles with a functional group by addition of a bioreactive organosilane to the microemulsion. The bioreactive organosilane may comprise aminopropyltrimethoxysilane (APTMS).

The method may further comprise the step of separating the dye-doped nanoparticles from the microemulsion. This may comprise addition of excess absolute ethanol to the microemulsion, and centrifusion twice with ethanol and once with deionised water. Sonication may be used between the washing steps to resuspend the nanoparticles. The dye-doped nanoparticles may be dispersed in deionised water, at 2.0 mg/ml and stored in the dark at 4° C.

According to a fourth aspect of the invention there is provided a method of determining a percentage weight of a dye which yields a required relative fluorescent intensity of a dye-doped nanoparticle, comprising the steps of

1. obtaining a measure of the radius of the nanoparticle,

2. determining the Forster radius of the dye,

3. for each of a plurality of % weights of the dye,

(i) determining the average distance between dye fluorophores in the nanoparticle,

(ii) determining the number of dye fluorophores in the nanoparticle,

(iii) determining the efficiency of Forster resonance energy transfer of the dye fluorophores using the Forster radius of the dye and the average distance between the dye fluorophores in the nanoparticle,

(iv) determining the relative fluorescent intensity of the nanoparticle using the number of dye fluorophores in the nanoparticle, the quantum efficiency of the dye and the efficiency of Forster resonance energy transfer of the dye fluorophores, and

4. determining the % weight of the dye which yields the required relative fluorescent intensity from the nanoparticle.

Determining the Forster radius of the dye may comprise calculating the radius using the excitation and emission spectra of the dye, the quantum efficiency, refractive index and dipole orientation factor of the dye, and Avogadro's number. The Forster radius may be calculated using

$${R}_{o}^{6} = \frac{9 φ ( Ln 10 ) {k}^{2} J}{128 {π}^{5} {n}^{4} {N}_{A}}$$

where φ is the quantum efficiency of the dye, k² is the dipole orientation factor, n is the refractive index of the dye, N_{A} is Avogadro's number, and J is integral of the overlap of the excitation and emission spectra of the dye. J may be calculated using

J=∫f_{D}(λ)ε_{A}(λ)λ⁴dλ

where f_{D} is the normalised emission spectrum of the dye and ε_{A} is the molar extinction coefficient of the dye.

The quantum efficiency of the dye, the dipole orientation factor, the refractive index of the dye, and the excitation and emission spectra of the dye may comprise reading values for these parameters from previously-acquired data, and/or measuring values for these parameters.

For each of the plurality of % weights of the dye, determining the average distance between dye fluorophores in the nanoparticle may comprise using the density and molecular weights of the dye fluorophores and the silica matrix of the nanoparticle. The average distance may be determined by determining the mole % of the dye fluorophores in the nanoparticle, and using this and assuming that the dye fluorophores pack inside the nanoparticle with equal spacing, calculating the average distance between each dye fluorophore.

For each of the plurality of % weights of the dye, determining the number of dye fluorophores in the nanoparticle may comprise using the density and molecular weights of the dye fluorophores and the silica matrix of the nanoparticle. The number of dye fluorophores may be determined by determining the mole % of the dye fluorophores in the nanoparticle, and using this and again assuming that the dye fluorophores pack inside the nanoparticle with equal spacing, calculating the number of dye fluorophores.

For each of the plurality of % weights of the dye, determining the efficiency of Forster resonance energy transfer of the dye fluorophores using the Forster radius R₀ of the dye and the average distance r between the dye fluorophores in the nanoparticle may comprise using

$${E}_{f} = \frac{1}{1 + {( r / {R}_{0} )}^{6}}$$

For each of the plurality of % weights of the dye, determining the relative fluorescent intensity of the nanoparticle using the number of dye fluorophores in the nanoparticle, the quantum efficiency of the dye and the efficiency of Forster resonance energy transfer of the dye fluorophores may comprise using

$$\frac{{F}_{T , n}}{{F}_{o}} = n \frac{1 - {E}_{f}}{1 - φ {E}_{f}}$$

where F_{T,n} is the total fluorescence from the excitation of the multiple dye fluorophores in the nanoparticle, F₀ is the fluorescence of a free fluorophore of the dye, n is the number of fluorophores excited and corresponds to the number of fluorophores in the nanoparticle, and φ is the quantum efficiency of the dye.

The ratio F_{T,n}/F₀ is the relative fluorescent intensity of the nanoparticle, and is a measure of the brightness of the nanoparticle.

F₀ may be determined by reading a value for this parameter from previously-acquired data, and/or measuring a value for this parameter.

Determining the % weight of the dye which yields the required relative fluorescent intensity from the nanoparticle may comprise determining the % weight of the dye which yields the maximum relative fluorescent intensity from the nanoparticle, or the % weight of the dye which yields a relative fluorescent intensity from the nanoparticle above a pre-determined threshold. The % weight of the dye which yields the required relative fluorescent intensity from the nanoparticle may be determined by plotting a graph of the % weight of the dye against relative fluorescent intensity from the nanoparticle, and using this to read the % weight of the dye which yields the required relative fluorescent intensity from the nanoparticle.

According to a fifth aspect of the invention there is provided a computer program product for determining a % weight of a dye which yields a required relative fluorescent intensity of a dye-doped nanoparticle, comprising
an input module which receives one or parameters of the dye and the nanoparticle,
a calculation module which determines the Forster radius of the dye,
a calculation module which, for each of a plurality of % weights of the dye,

(i) determines the average distance between dye fluorophores in the nanoparticle,

(ii) determines the number of dye fluorophores in the nanoparticle,

(iii) determines the efficiency of Forster resonance energy transfer of the dye fluorophores using the Forster radius of the dye and the average distance between the dye fluorophores in the nanoparticle, and

(iv) determines the relative fluorescent intensity of the nanoparticle using the number of dye fluorophores in the nanoparticle, the quantum efficiency of the dye and the efficiency of Forster resonance energy transfer of the dye fluorophores,
a calculation module which determines the % weight of the dye which yields the required relative fluorescent intensity from the nanoparticle, and
an output module which outputs the % weight of the dye which yields the required relative fluorescent intensity from the nanoparticle.

Embodiments of the invention will now be described by way of example only, with reference to the accompanying drawings, in which:

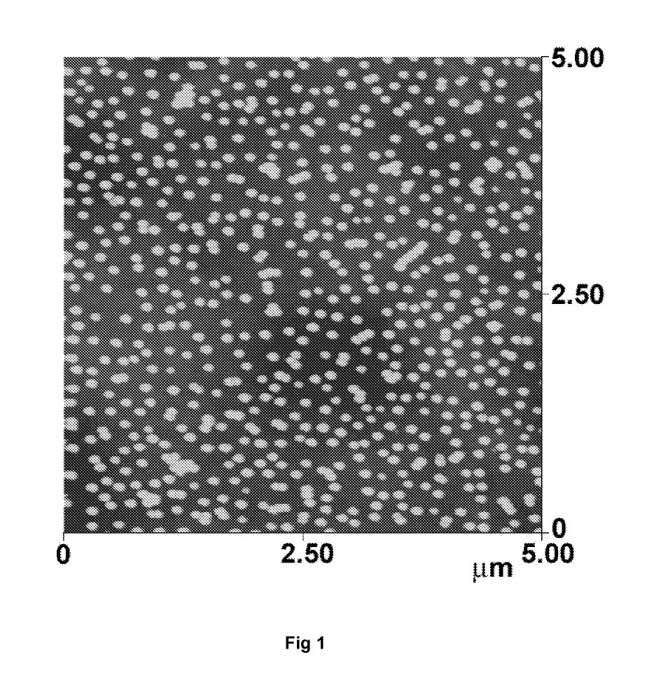

FIG. 1 is an Atomic Force Microscopy image of a plurality of dye-doped nanoparticles according to the invention;

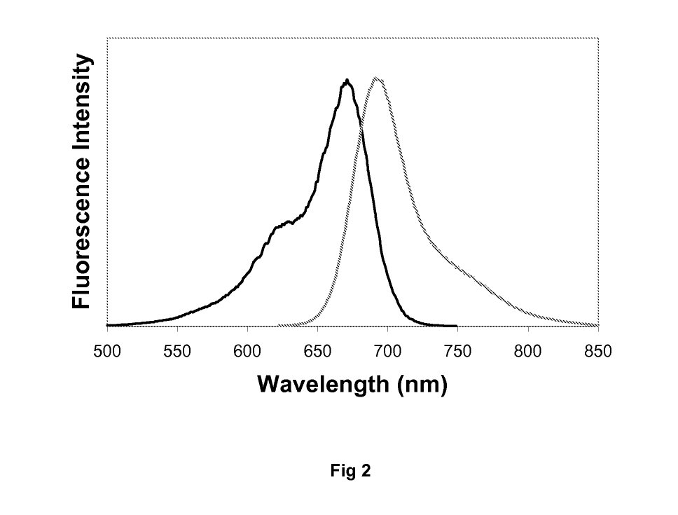

FIG. 2 is a schematic representation of excitation and emission spectra of the dye NIR-664-N-succinimidyl ester used in the nanoparticles of the invention, in isopropanol;

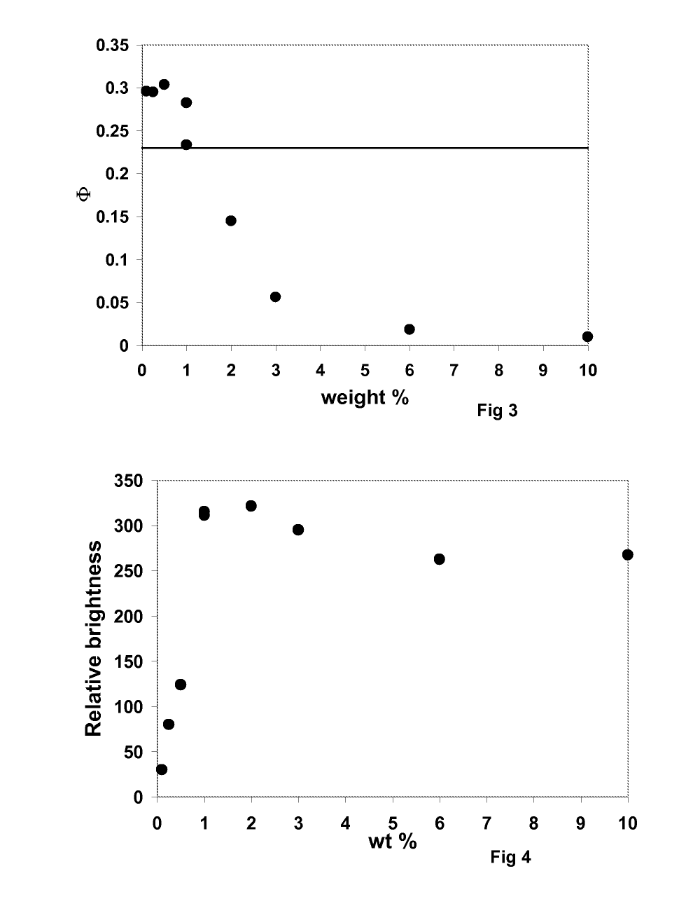

FIG. 3 is a schematic representation of change in the quantum efficiency of the dye NIR-664-succinimidyl ester as the weight % thereof is increased inside the dye-doped nanoparticles;

FIG. 4 is a schematic representation of change in relative brightness with increasing dye loading inside the dye-doped nanoparticles of the invention;

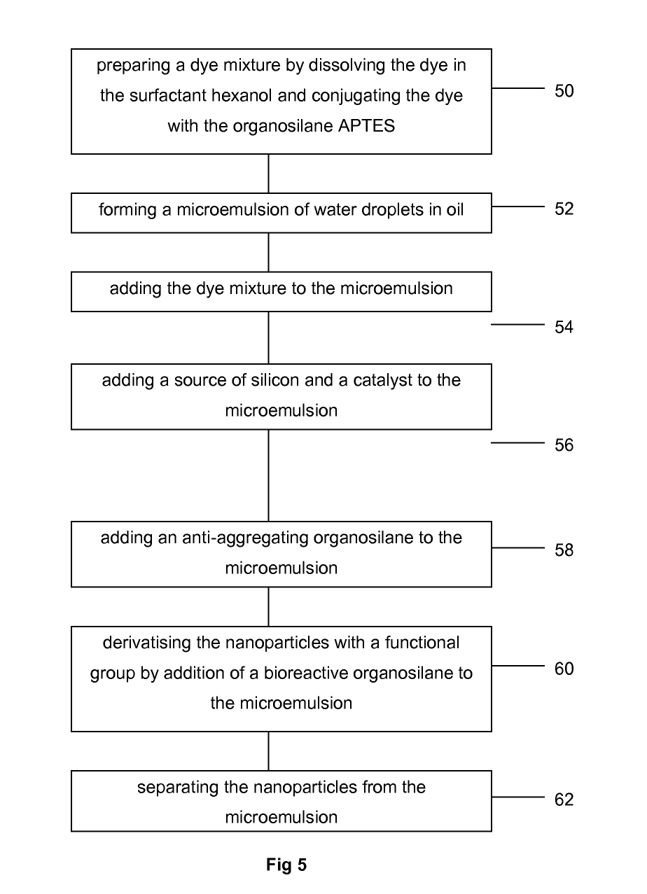

FIG. 5 is a flow chart of the method of manufacture of the dye-doped nanoparticles;

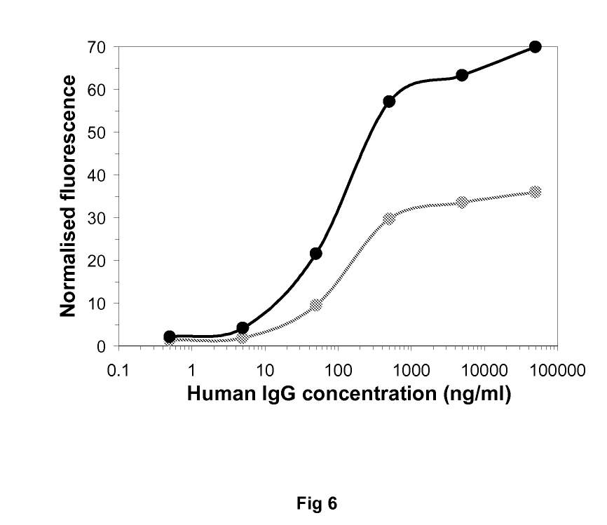

FIG. 6 is a schematic representation of a human IgG sandwich fluorescence linked immunoabsorbant assay using goat anti human IgG antibody conjugated to dye-doped nanoparticles of the invention (•) and Cy5 ( [symbol] ) and

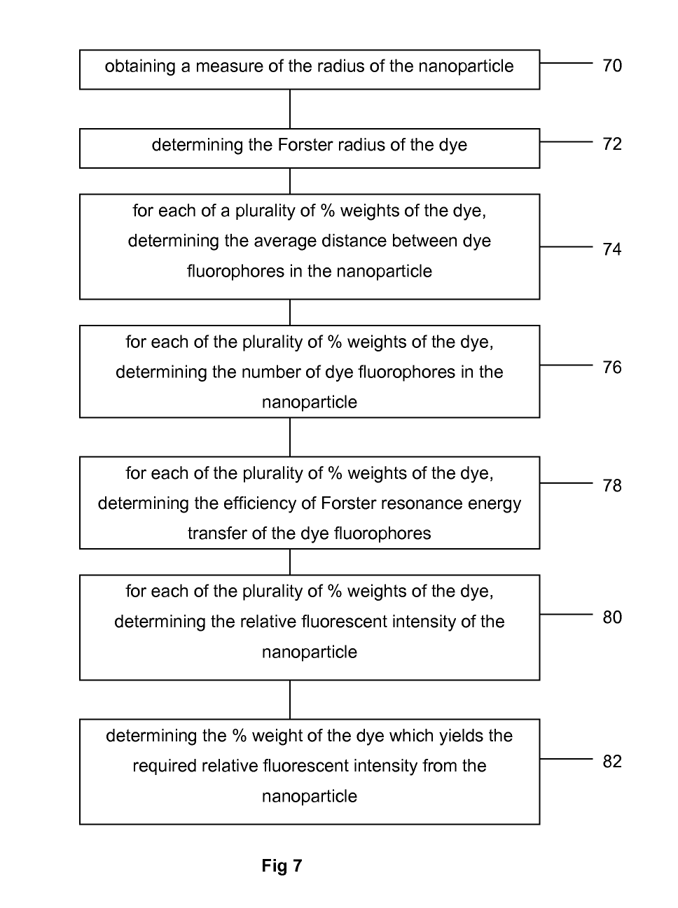

FIG. 7 is a flow chart of, in a dye-doped nanoparticle, the method of determining a % weight of the dye which yields a required relative fluorescent intensity from the nanoparticle.

FIG. 1 shows an Atomic Force Microscopy image of a plurality of dye-doped nanoparticles according to the invention. The dye-doped nanoparticles 1 each comprise a silica matrix with a plurality of dye molecules dispersed therein. The dye molecules are substantially homogeneously dispersed in the silica matrix. The dye molecules comprise 4,5-Benzo-1′-ethyl-3,3,3′,3′-tetramethyl-1-(4-sulfobutyl)indodicarbocyanin-5′-acetic acid N-succinimidyl ester (which is an organic dye, is more commonly referred to as NIR-664-N-succinimidyl ester, and is supplied by Sigma Aldrich). At least some of the dye molecules are conjugated to aminopropyltriethoxysilane, for covalent attachment to the silica matrix. The dye has a quantum efficiency of 23% and an extinction coefficient of 187,000 l mol⁻¹ cm⁻¹. The dye molecules fluoresce in the near infra red (NIR) part of the electromagnetic spectrum, and have fluorescence excitation and emission wavelengths of 672 nm and 694 nm respectively in isopropanol (see FIG. 2).

For the dye-doped nanoparticles 1 comprising NIR-664-succinimidyl ester dye molecules trapped inside a silica matrix with a refractive index of 1.5, a Forster radius of 5.35 nm was calculated. The Forster radius is quite large because its value is directly proportional to the integral of the overlap between the excitation and emission spectra of the dye molecules. In common with other organic NIR dyes, such as Cy5 or Alexa Fluor 647, there is significant overlap of the excitation and emission spectra for the NIR-664-succinimidyl ester dye molecules. Moreover, the overlap integral is dependent on the fourth power of the wavelength, and since the wavelength is longer for NIR dyes the integral value is increased further.

The dye-doped nanoparticles 1 have been characterised using dynamic light scattering (DLS), ultra violet (UV) spectroscopy, Atomic Force Microscopy (AFM) and Transmission Electron Microscopy (TEM).

DLS measurements were performed on a Zetasizer from Malvern Instruments. For samples of dye-doped nanoparticles 1 prepared with different weight percent of dye molecules, nanoparticle diameter and ζ potentials were measured using DLS, and are shown in the following table. The nanoparticle diameters obtained from the DLS measurements are slightly larger than the actual diameters of the nanoparticles, because they include the hydrodynamic radius. The potentials ζ were high for all the wt % s.

| wt % | Ø (nm) | ζ(mV) |
|---|---|---|
| 0.25 | 102 | −37.8 |
| 0.5 | 103 | −37.5 |
| 1 | 104 | −35.5 |
| 2 | 105 | −42.7 |
| 3 | 108 | −42.3 |
| 6 | 110 | −42.7 |
| 10 | 107 | −39.4 |

In the DLS measurements, only one peak was observed indicating that the dye-doped nanoparticles are monodispersed in size.

AFM measurements were performed on a “Dimensions 3100 AFM” from Digital Instruments. Analysis was performed in tapping mode using silicon tips purchased from Veeco. AFM images were analyzed using freeware software WSxM from Nanotec Electronica. From the AFM images, the majority of the dye-doped nanoparticles 1 are similar in size and are not linked to other nanoparticles. The average height of the dye-doped nanoparticles 1 was approximately 62 nm.

TEM micrographs were obtained using a Hitachi 7000 Transmission Electron Microscope operated at 100 kV. Images were captured digitally using a Megaview 2 CCD camera. Specimens were prepared by dropping aqueous solutions of the nanoparticles 1 onto a formvar carbon coated copper grid. Using TEM, the average dye-doped nanoparticle diameter of a sample of nanoparticles having approximately 3 wt % of dye molecules was measured as approximately 80 nm+/−5 nm.

We used a standard referencing method to calculate the quantum efficiency of the dye molecules inside the dye-doped nanoparticles 1, using free dye in a solution as a reference. The ratio of the fluorescence of the dye inside the nanoparticles to the fluorescence of the free dye in solution is equal to the ratio of the quantum efficiencies of the dye inside the nanoparticles and the free dye in solution. Fluorescence measurements of the nanoparticles 1 and the free dye in solution were performed on a Safire (Tecan) microplate reader. All instrument parameters and experimental conditions, including dye concentration, are kept the same for all fluorescence measurements. To determine the concentration of the dye inside the nanoparticles and the free dye in solution, Beer Lambert's law was used. We measured the absorbance of the nanoparticles at 670 nm in isopropanol, and assumed the extinction coefficient to be equal to that of the free dye in isopropanol at 187,000 l mol⁻¹ cm⁻¹. For the low weight % s, up to 1 wt %, the value for the free dye concentration is a good approximation of the concentration of dye inside the nanoparticles. At higher wt % s we observed significant aggregation of the dye molecules. We did not recalculate the extinction coefficient and therefore the QE determined at higher weight % s is probably an overestimation of the true value. FIG. 3 shows the change in quantum efficiency with the weight % of dye inside the silica nanoparticles 1. The black line corresponds to the quantum efficiency of free dye at 23%. For loadings of less than 1 wt % of dye in the nanoparticles, we obtained a slight increase in the quantum efficiency to 30%. Quantum efficiencies increase if the rate of radiative decay increases relative to non radiative decay. In a protected environment such as a non porous silica nanoparticle, the dyes do not interact with molecular quenchers. In addition, the rotational and vibration freedom of the dye is decreased. All of these factors increase the ratio of radiative decay over non radiative decay. From UV-vis extinction spectra of colloidal suspensions of the nanoparticles 1 measured using a Cary 50 scan UV-Visible spectrophotometer (Varian Ltd) in transmission mode, we observed changes in the extinction spectra of the nanoparticles with solvent and concluded the particles were microporous. Moreover, we did not attempt to reduce porosity by lowering the pH during synthesis. We believe the lower quantum efficiency of NIR-664-succinimidyl ester dye molecules at low weight % s in the nanoparticles 1 is due to dye interaction with molecular quenchers. The low quantum efficiencies at higher weight % s is due to energy transfer.

The relative brightness of the dye-doped nanoparticles 1 was determined, using fluorescence measurements from the dye in the nanoparticles and fluorescence measurements from free dye in solution. In all fluorescence experiments we used a starting concentration of 2 mg/ml of nanoparticles in isopropanol. This corresponds to a nanoparticle concentration of 4.3×10⁻⁹ mol 1⁻¹. We measured the fluorescence of the nanoparticles over a range of dilutions and compared with the fluorescence of pure dye of known concentration. All experiments were performed at the same instrument settings and constant temperature. The relative brightness of the nanoparticles is the fluorescence of the dye in the nanoparticles divided by the fluorescence of the free dye at the same dye concentration. The relative brightness of the nanoparticles versus the weight % of dye inside the nanoparticles is shown in FIG. 4. At very low loadings of less than 1 wt % dye we observed a steep increase in fluorescence and hence relative brightness, and observed a maximum fluorescence and relative brightness at 2 wt %. However there was very little difference between the fluorescence/relative brightness of the nanoparticles with 1 and 2 wt % dye loadings. At higher loadings the fluorescence/relative brightness dropped off slightly. For the nanoparticles, the maximum brightness from experiment was 321.

We also determined the brightness using Weisner's method. In this method the brightness is calculated from the ratio of the quantum efficiencies of the dye inside the nanoparticles and pure dye multiplied by the number of dye molecules inside the nanoparticles. We obtained very similar values to those obtained from experiment.

In this aspect of the invention, silica nanoparticles doped with molecules of a NIR dye is provided. The dye, 4,5-Benzo-1′-ethyl-3,3,3′,3′-tetramethyl-1-(4-sulfobutyl)indodicarbocyanin-5′-acetic acid N-succinimidyl ester, is a relatively cheap dye in comparison to other commercially available dyes, is able to act as a surrogate dye to those normally used, e.g. Cy5, and exhibits more than two orders of magnitude increase in brightness compared to a single Cy5 dye molecule. This translates into improved assay performance when using the nanoparticles of the invention, including enhanced sensitivity and lower limit of detection (LOD).

The materials used in the manufacture of the dye-doped nanoparticles are as follows: Triton® X-100 (Union Carbide), n-hexanol (anhydrous, >99%), cyclohexane (anhydrous 99.5%), ammonium hydroxide (28% in H₂O>99.99%), tetraethylorthosilica (TEOS, 99.99%), aminopropyltrimethoxysilane (APTMS, 97%), aminopropyltriethoxysilane (APTES, 99%), 3-(trihydroxysilyl)propyl methyl phosphonate, monosodium salt solution (THPMP, 42 wt % in water), triethylamine (>99%), absolute ethanol, all purchased from Sigma Aldrich and used without further purification, and deionised water >18 MΩ from a Millipore academic system.

Dye-doped nanoparticles according to the invention are prepared using a microemulsion method. Specifically, nanoparticles containing 0.25, 0.5, 1, 2, 3, 6 and 10 wt % of dye (NIR-664-succinimidyl ester) have been prepared using the microemulsion method. The steps of the manufacturing method of 2 wt % nanoparticles are illustrated in FIG. 5, all other weight % s were prepared in a similar way.

In a first step 50, a dye mixture is prepared by dissolving the dye in the surfactant hexanol, and conjugating the dye with the organosilane APTES. Specifically, 15.6 mg of the dye is dissolved in 5 ml of anhydrous n-hexanol, and 5.021 μl of pure APTES and 3 μl of triethylamine are added thereto. The resultant dye mixture is agitated for 24 hours, so that conjugation of the dye to the APTES takes place. Preparing and using such a dye mixture overcomes two problems in the manufacture and stability of the dye-doped nanoparticles of the invention. The dye used in the nanoparticles of the invention is not soluble in water. It has been found that if a dye mixture is prepared by dissolving the dye in the surfactant hexanol, when this mixture is subsequently added to the microemulsion to form the dye-doped nanoparticles, ease of formation of the dye-doped nanoparticles is increased. The n-hexanol is also used, as a co-surfactant, in the subsequent microemulsion formation, and therefore its use in the preparation of the dye mixture has no adverse effects on this microemulsion formation. With regard to the stability of the dye-doped nanoparticles, if these are porous significant leaching of the dye from the nanoparticles can occur. It has been found that in porous nanoparticles prepared using the microemulsion method, about 90% of dye molecules leach out within 72 hours. Non porous silica nanoparticles can be prepared by lowering the pH used in the preparation process. Non porous silica nanoparticles leach less than 5% of the dye over the same period of time. However, lowering the pH also causes the dye to aggregate, become unstable and to degrade to a non-fluorescent derivative. It has been found that this can be overcome by adding the organosilane APTES to the dye dissolved in hexanol. APTES is a bifunctional ligand that contains both a dye-reactive amine group and a vitreophilic group. The amine group reacts with the succinimidyl ester group on the dye, via nucleophilic attack, to form a strong amide bond thereto. Such conjugation of the dye with the APTES, prior to its incorporation into the nanoparticles, allows the subsequent dye-doped nanoparticle formation to take place at relatively high pH values. Thus nanoparticles with a low residual porosity are produced, which reduces leaching. Over a two month period no leaching at all was observed in dye-doped nanoparticles produced using dye conjugated with APTES.

In a second step 52, a microemulsion of water droplets in oil is formed. Firstly, cyclohexane oil phase (15 ml), and surfactants n-hexanol co-solvent (3.256 ml) and Triton® X-100 (3.788 g) are mixed in 30 ml plastic bottles. Then 0.96 ml of deionised water is added, and the solution stirred for five minutes, and a microemulsion comprising water droplets in oil is formed. The surfactants act to stabilise the droplets in the oil.

In a third step 54, the dye mixture is added to the microemulsion. Specifically, 0.344 ml of the dye mixture is added to the microemulsion.

In a fourth step 56, a source of silicon and a catalyst are added to the microemulsion. Specifically, 0.2 ml of a source of silicon, TEOS, and 0.16 ml of a catalyst, NH₄OH, are added to the microemulsion, five minutes after the addition of the dye mixture.

Silica nanoparticles grow in the water droplets of the microemulsion, and the silica nanoparticles are doped with the dye. In the dye mixture, the dye is conjugated with the APTES. The APTES comprises a triethoxysilane group which attaches to the growing silica nanoparticles via the sol-gel process. The microemulsion is stirred for 24 hrs, after which 0.1 ml of TEOS is added with rapid stirring.

In this embodiment of the method, a fifth step 58 is carried out, which comprises addition of an anti-aggregating organosilane to the microemulsion. Specifically, after 30 minutes 0.08 ml of the organosilane THPMP is added to the microemulsion with stirring, which prevents aggregation of the dye-doped nanoparticles.

In this embodiment of the method, a sixth step 60 is carried out, which comprises derivatising the dye-doped nanoparticles with a functional group by addition of a bioreactive organosilane to the microemulsion. Specifically, after a further 5 minutes, 0.02 ml of the bioreactive organosilane APTMS is added to the microemulsion, which is stirred for a further 24 hours. The APTMS has a free primary amine group for crosslinking to biomolecules, for example conjugation with antibodies.

In a seventh step 62, the dye-doped nanoparticles are separated from the microemulsion. This comprises the addition of excess absolute ethanol to the microemulsion, and centrifusion twice with ethanol and once with deionised water. Sonication is used between the washing steps to resuspend the nanoparticles. The dye-doped nanoparticles are dispersed in deionised water, at 2.0 mg/ml and stored in the dark at 4° C.

To assess the performance of the dye-doped nanoparticles of the invention, a standard fluorescence-linked immunoassay was carried out using the dye-doped nanoparticles conjugated to the antibody, goat anti human IgG, for the detection of changes in concentration of human IgG antibody. The results were compared against the commercial NIR dye label, Cy5, conjugated to the goat anti human IgG antibody.

The materials used were: polyclonal Cy5 conjugated goat anti human IgG (2.5 mg/ml in PBS), polyclonal goat anti human IgG (5 mg/ml in PBS) and polyclonal human IgG (5 mg/ml in PBS) purchased from Biomeda, monobasic sodium phosphate, dibasic sodium phosphate, phosphate buffered saline (PBS, pH 7.4, 0.01 M), Tween® 20 (Uniqema), glutaraldehyde (25 wt % in water), sodium azide (99.99%) and albumin from bovine serum (BSA, 98%).

The NIR-664-succinimidyl ester dye-doped nanoparticles of the invention were conjugated to the polyclonal goat anti human IgG antibody. In a first step, 2 mg of the nanoparticles were dispersed in 1 ml of phosphate buffer at pH 7.0. To this solution was added 0.1 ml of 1 wt % glutaraldehyde and 20 mg of BSA. The solution was then stirred for 24 hours in the dark at 4° C. The nanoparticles were centrifuged and resuspended in 1 ml of phosphate buffer containing 0.25 mg of the polyclonal goat anti human IgG antibody. To this solution was added 0.1 ml of 1 wt % glutaraldehyde and the solution agitated for a further 24 hours. Finally the solution was centrifuged and stored in PBS containing 0.1 wt % BSA and 0.04 wt % sodium azide. The result is a nanoparticle-labelled polyclonal goat anti human IgG antibody with a BSA as a spacer. The BSA increased the flexibility of the label and reduced steric hindrance between the label and a silica support Glutaraldehyde was used to link the BSA to the nanoparticles and to link the antibody to the BSA.

A fluorescence linked immunosorbent assay (FLISA) was carried out, to test the performance of the nanoparticles. Black 96 well plates used in the FLISA were purchased from AGB scientific. A sandwich assay format was used. In a first step, 100 μl of polyclonal goat anti human IgG, at 5 μg/ml was added to each well of a standard 96 well microplate. The plate was then incubated overnight at 4° C. To remove any non adsorbed antibody the plate was rinsed three times with PBS and three times with PBS/0.05 wt % Tween®. To block the plate, 200 μl of 1 wt % BSA in PBS was added to each well and the plate incubated at 37° C. for 1 hour. The rinse cycle was then repeated. Following this 100 μl aliquots of human IgG in 0.1 wt % BSA were added in a series of dilutions from 500,000 ng/ml to 0.5 ng/ml to each well and the plate incubated at 37° C. for 1 hour. The rinse cycle was repeated to remove any non specifically bound human IgG. Finally 100 μL aliquots of goat anti human IgG conjugated nanoparticles at 0.2 mg/ml were added to each well and the plate incubated for a further hour at 37° C. in the dark. Prior to analysis the plate was rinsed one more time. In a parallel study the nanoparticle label of the invention was replaced with Cy5 conjugated goat anti human IgG label at a concentration of 0.025 mg/ml. The Cy5 label was purchased in the conjugated form to polyclonal goat anti human IgG (Abs 630/280=3/1).

Using DLS we measured the particle diameter and ζ potential of 1 wt % dye doped nanoparticles before and after conjugation to the goat anti human IgG antibody. The diameter increased from 104 nm to 113 nm relating to the deposition of a covering layer of antibodies. The ζ potential dropped from −35.5 to −17.6 mV. The nanoparticles coated with the stabilizing group THPMP have a high surface charge and subsequently a high ζ potential. Antibodies have regions of positive and negative charge and the lower ζ potential is further evidence of the conjugation of a layer of antibodies. The results from the FLISA are shown in FIG. 6, and give normalised fluorescence, which is equal to the absolute fluorescent signal divided by the signal at zero concentration of human IgG. It can be seen that the change in fluorescence signal with change in human IgG concentration, called the sensitivity, was found to be significantly greater for the nanoparticle label of the invention. Moreover, the normalised fluorescence signal for this nanoparticle label at 1000 ng/ml was almost twice that of the signal from the Cy5 label. Such increases in sensitivity are required if cost effective biomedical diagnostic devices are to be realised. The limit of detection (LOD) for both the nanoparticle label and the Cy5 label is less than 5 ng/ml.

The use of the dye-doped nanoparticles of the invention as a label resulted in improved assay performance. This indicates the potential of these nanoparticles for improving assay performance.

It will be understood that use of the dye-doped nanoparticles of the invention is not limited to that given above. The nanoparticles may also be used in, for example, immunocytochemistry, flow cytometry and DNA/protein microarray analysis.

The method of determining a % weight of a dye which yields a required relative fluorescent intensity from a nanoparticle which is doped with the dye was tested for the dye-doped nanoparticles 1.

When a single dye fluorophore is used as a source of fluorescence, for such a fluorophore in isolation at low concentration, the fluorescence F₀ is defined as

F₀=I₀εφ

where I₀ is the intensity of the excitation source, ε is the extinction coefficient and φ is the quantum efficiency of the dye.

When a number of dye fluorophores exist together, energy may be emitted by the dye fluorophores by fluorescence, and also by energy transfer between the dye fluorophores. The energy transfer between the dye fluorophores is known as homo-Forster resonance energy transfer (HFRET). This is the process whereby the energy from the oscillating dipole of an optically excited dye fluorophore, called the donor fluorophore, is transferred to an electric dipole of an excitable dye fluorophore in its ground state, called the accepter fluorophore. When the donor fluorophore transfers energy in this way, the fluorescence of the donor fluorophore is F₀* where

F₀*=I₀εφ(1−E_{f})

It can be seen that the fluorescence of the donor fluorophore is reduced from the fluorescence of a fluorophore in isolation, by the amount (1−E_{f}), where the term E_{f} is called the efficiency of HFRET. After excitation of a donor fluorophore in close proximity to an accepter fluorophore, the energy received by the donor fluorophore can be lost to the surroundings in two ways described above: radiative decay (fluorescence) and/or non radiative decay (molecular quenching by HFRET). HFRET is a near-field effect. After each HFRET event a proportion of energy can then be lost via non radiative decay. Therefore, with each FRET event the amount of energy available for fluorescence decreases.

The efficiency of the HFRET is defined as

$${E}_{f} = \frac{1}{1 + {( r / {R}_{0} )}^{6}}$$

where r is the average distance between a donor fluorophore of the dye and an accepter fluorophore of the dye, and R₀ is the so-called Forster radius.

In the invention, each dye-doped nanoparticle can comprise a plurality of dye fluorophores. It is desirable to provide a number of dye fluorophores together in a nanoparticle, as this can increase the overall fluorescence emitted from the nanoparticle and increase the efficacy of the nanoparticle in assays. However, providing a number of dye fluorophores together will lead to HFRET, and this will lead to a decrease in the overall fluorescence emitted from the nanoparticle. It is therefore important to choose a number of dye fluorophores in the nanoparticle that will balance these two competing effects on the fluorescence.

The efficiency of the HFRET is highly dependent on the average distance between the dye fluorophores, r. For a given nanoparticle volume, this average distance depends on the weight %, or loading, of the dye in the nanoparticle. As the weight % of the dye in the nanoparticle increases, the number of dye fluorophores in the nanoparticle increases, and this increases the potential for enhancing the fluorescence of the nanoparticle. However, as the weight % of the dye in the nanoparticle increases, the average distance between the dye fluorophores decreases, which increases the efficiency of the HFRET, and this decreases the potential for enhancing the fluorescence of the nanoparticle.

The efficiency of the HFRET is also dependent on the Forster radius of the dye, a larger Forster radius leads to a larger efficiency of the HFRET. The Forster radius is the distance between two dye fluorophores which will result in an efficiency of HFRET of 50%. For a particular dye, the Forster radius is directly proportional to the integral of the overlap between the excitation and emission spectra of the dye, and the overlap integral is dependent on the fourth power of the excitation and emission wavelengths of the dye. The excitation and emission wavelengths and their overlap are determined by the chemistry of the dye. It is desirable to use NIR dyes as labels in bioassays, as at NIR wavelengths there is low background interference from fluorescence of biological molecules, solvents and substrates. For NIR dyes, such as that used in the invention, NIR-664-succinimidyl ester, and other organic NIR dyes, such as Cy5 or Alexa Fluor 647, there is significant overlap of the excitation and emission spectra, and since the excitation and emission wavelengths are, by definition, longer for NIR dyes the overlap integral is increased further. Therefore for NIR dyes, the Forster radius will be large, which leads to a large efficiency of the HFRET, and this decreases the potential for enhancing the fluorescence of a plurality of fluorophores of the dye. For example, for the dye used in the invention, trapped inside a silica matrix with a refractive index of 1.5, a Forster radius of 5.35 nm was calculated. Thus in the invention it is even more important to be able to choose a number of dye fluorophores in the nanoparticle that will yield a required fluorescence from the nanoparticle.

The method of the fourth aspect of the invention enables such a choice to be made.

This method comprises the following steps in a dye-doped nanoparticle comprising a silica matrix and the dye, NIR-664-succinimidyl ester,

1. obtaining a measure of the radius of the nanoparticle,

2. determining the Forster radius of the dye,

3. for each of a plurality of % weights of the dye,

(i) determining the average distance between dye fluorophores in the nanoparticle,

(ii) determining the number of dye fluorophores in the nanoparticle,

(iii) determining the efficiency of Forster resonance energy transfer of the dye fluorophores using the Forster radius of the dye and the average distance between the dye fluorophores in the nanoparticle,

(iv) determining the relative fluorescent intensity of the nanoparticle using the number of dye fluorophores in the nanoparticle, the quantum efficiency of the dye and the efficiency of Forster resonance energy transfer of the dye fluorophores, and

4. determining the % weight of the dye which yields the required relative fluorescent intensity from the nanoparticle.

The method is illustrated in the flow chart of FIG. 7.

Determining the Forster radius of the dye, step 72, comprises calculating the radius using the excitation and emission spectra of the dye, the quantum efficiency, refractive index and dipole orientation factor of the dye, and Avogadro's number. The Forster radius is calculated using

$${R}_{o}^{6} = \frac{9 φ ( Ln 10 ) {k}^{2} J}{128 {π}^{5} {n}^{4} {N}_{A}}$$

where φ is the quantum efficiency of the dye, k² is the dipole orientation factor, n is the refractive index of the dye, N_{A} is Avogadro's number, and J is integral of the overlap of the excitation and emission spectra of the dye. J is calculated using

J=∫f_{D}(λ)ε_{A}(λ)λ⁴dλ

where f_{D} is the normalised emission spectrum of the dye and ε_{A} is the molar extinction coefficient of the dye.

The quantum efficiency of the dye, the dipole orientation factor, the refractive index of the dye, and the excitation and emission spectra of the dye may comprise reading values for these parameters from previously-acquired data, and/or measuring values for these parameters.

For each of the plurality of % weights of the dye, determining the average distance between dye fluorophores in the nanoparticle, step 74, comprises using the density and molecular weights of the dye fluorophores and the silica matrix of the nanoparticle. The average distance is determined by determining the mole % of the dye fluorophores in the nanoparticle, and using this and assuming that the dye fluorophores pack inside the nanoparticle with equal spacing, calculating the average distance between each dye fluorophore.

For each of the plurality of % weights of the dye, determining the number of dye fluorophores in the nanoparticle, step 76, comprises using the density and molecular weights of the dye fluorophores and the silica matrix of the nanoparticle. The number of dye fluorophores is determined by determining the mole % of the dye fluorophores in the nanoparticle, and using this and again assuming that the dye fluorophores pack inside the nanoparticle with equal spacing, calculating the number of dye fluorophores.

For each of the plurality of % weights of the dye, determining the efficiency of Forster resonance energy transfer of the dye fluorophores, step 78, using the Forster radius R₀ of the dye and the average distance r between the dye fluorophores in the nanoparticle, comprises using

$${E}_{f} = \frac{1}{1 + {( r / {R}_{0} )}^{6}}$$

For each of the plurality of % weights of the dye, determining the relative fluorescent intensity of the nanoparticle, step 80, using the number of dye fluorophores in the nanoparticle, the quantum efficiency of the dye and the efficiency of Forster resonance energy transfer of the dye fluorophores, comprises using

$$\frac{{F}_{T , n}}{{F}_{o}} = n \frac{1 - {E}_{f}}{1 - φ {E}_{f}}$$

where F_{T,n} is the total fluorescence from the excitation of the multiple dye fluorophores in the nanoparticle, F₀ is the fluorescence of a free fluorophore of the dye, n is the number of fluorophores excited and corresponds to the number of fluorophores in the nanoparticle, and φ is the quantum efficiency of the dye.

The ratio F_{T,n}/F₀ is the relative fluorescent intensity of the nanoparticle, and is a measure of the brightness of the nanoparticle.

F₀ may be determined by reading a value for this parameter from previously-acquired data, and/or measuring a value for this parameter.

This equation has been derived by the inventors. It has been realised that the total fluorescence, F_{T,n}, is the sum of the fluorescence from donor fluorophores, F₀*, plus the fluorescence from each of the dye fluorophores that have gained energy via HFRET from the excitation of the donor fluorophore.

From the above equation it can be seen that the brightness of a nanoparticle depends on both the efficiency of HFRET and the quantum efficiency of the dye. In the special case where the quantum efficiency is 100% there is no loss in energy from HFRET and the brightness increases linearly with the number of dye fluorophores. Using a Forster radius of 5.35 nm we calculated the reduction in brightness of a single accepter/donor fluorophore pair with change in separation distance between them and changing quantum efficiency. At a constant separation distance the brightness does not change significantly with changes in φ until φ approaches close to 100%. Therefore, a change from a low φ dye (25%) to a higher φ dye (50%) would not result in a significant increase in performance. It is clear that brightness is more dependent on the efficiency of HFRET. At short separation distances almost all the fluorescence is quenched, whereas at large distances the fluorescence is unaffected by other dye fluorophores. The greatest change occurs at distances close to the Forster radius.

Determining the % weight of the dye which yields the required relative fluorescent intensity from the nanoparticle, step 82, may comprise, for example, determining the % weight of the dye which yields the maximum relative fluorescent intensity from the nanoparticle, or the % weight of the dye which yields a relative fluorescent intensity from the nanoparticle above a pre-determined threshold. The % weight of the dye which yields the required relative fluorescent intensity from the nanoparticle may be determined by plotting a graph of the % weight of the dye against relative fluorescent intensity from the nanoparticle, and using this to read the % weight of the dye which yields the required relative fluorescent intensity from the nanoparticle.

The method was used for the dye of the invention, NIR-664-succinimidyl ester dye. As would be expected the brightness increases with particle size. However, larger particles have slower kinetics and are less desirable for biomedical diagnostics. The brightness also increased with the number of dye molecules at very low loadings. However, as the number of dye molecules increased and their intermolecular separation decreased the brightness drops significantly. The maximum brightness for a nanoparticle with a radius of 28 nm was found to be 342, with a dye loading of 682 molecules or 0.37 wt %. At this value half the excited energy that would normally appear as fluorescence is being lost via energy transfer and subsequent non-radiative decay. At this value the dye molecules are approximately 5.1 nm apart which is slightly shorter than the Forster radius, at 5.35 nm. Even at such a low loading of dye molecules there is not enough distance between the dye molecules to prevent a significant drop in fluorescence.

Experimental results were compared with relative intensity values determined using the method above. A radius of 28 nm for the HFRET calculation was used, as apposed to the experimental radius of 42.5 nm. We assume the dye conjugated to the silica nanoparticles prior to formation of the silica shell containing the stabilising group THPMP. From experiment the size of these nanoparticles is approximately 56 nm. It would be incorrect to use a larger particle size in the model since this would lead to a larger intermolecular separation distances between dyes and lower rates of energy transfer. This is significantly higher value than the loading obtained from HFRET calculations, at approximately 0.4 wt %. The experimental weight percent is calculated from the weight of dye added at the start of the experiment. The conjugation efficiency of the dye to amines is reported to be 70%. In addition, the high pH used for catalysis of silica formation leads to degredation of a percentage of the dye. Moreover, it is not likely that all the dye added will conjugate to the nanoparticles. At higher loadings the fluorescence dropped off slightly.

In previous work using Ru(bpy)₃ a loadings of 21 wt % was achieved without a drop in fluorescence. The Stokes shift of the Ru complex, at 157 nm, is significantly higher than the shift for the NIR-664 dye used in this study, at 22 nm. Therefore, the overlap integral between excitation and emission spectra of the Ru(bpy)₃ is significantly smaller and the Forster radius much shorter. Hence the energy losses due to energy transfer are much less significant. However, dyes that fluoresce at shorter wavelengths are less desirable for biomedical diagnostics. For the nanoparticles 1, the maximum brightness from experiment and theory were 321 and 342, respectively. The Ru(bpy)₃ doped silica nanoparticles were approximately 72000 brighter than the free dye at the same concentration. Although the nanoparticles of the invention are significantly less bright than Ru(bpy)₃ doped nanoparticles they are still considerably brighter than a single dye fluorophore. Moreover, functionalised organic dyes that fluoresce in the NIR region are generally expensive and loading these dyes at higher weight percents for commercial applications is cost prohibitive.

From simulation, the nanoparticles of the invention were approximately 340 times brighter at a maximum weight of 0.4%. The maximum brightness from the experiments matched closely with the model described above.

Using the method above the influence of HFRET on the fluorescence of a NIR dye doped silica nanoparticle at different weight percents can be calculated. The optimum weight percent for minimum HFRET and maximum fluorescence can be determined. The method can be used as a predictive tool in order to optimise dye loading for maximum enhancement for NIR dye-doped nanoparticles.

1. Dye-doped nanoparticles comprising silica doped with molecules of a near infra red dye comprising 4,5-Benzo-1′-ethyl-3,3,3′,3′-tetramethyl-1-(4-sulfobutyl)indodicarbocyanin-5′-acetic acid N-succinimidyl ester.

2. The dye-doped nanoparticles according to claim 1, comprising a silica matrix with the dye molecules dispersed therein.

3. The dye-doped nanoparticles according to claim 2, wherein the dye molecules are substantially homogeneously dispersed in the silica matrix of the nanoparticles.

4. The dye-doped nanoparticles according to claim 1, wherein the dye-doped nanoparticles are substantially amorphous.

5. The dye-doped nanoparticles according to claim 1, wherein the dye-doped nanoparticles are microporous.

6. The dye-doped nanoparticles according to claim 1, wherein the dye-doped nanoparticles comprise approximately 1 wt % of the dye molecules.

7. The dye-doped nanoparticles according to claim 1, wherein the dye-doped nanoparticles are substantially spherical, and comprise an average diameter of approximately 80 nm+/−5 nm.

8. The dye-doped nanoparticles according to claim 1, wherein the dye-doped nanoparticles have a brightness which is approximately two or more orders of magnitude brighter than a single dye molecule, such as Cy5 dye.

9. The dye-doped nanoparticles according to claim 1, wherein at least some of the dye molecules are conjugated to an organosilane.

10. A dye-doped nanoparticle according to claim 1, wherein the dye-doped nanoparticle is derivatised with a functional group.

11. A method of manufacture of dye-doped nanoparticles comprising the steps of:
preparing a dye mixture by dissolving a dye in the surfactant hexanol and conjugating the dye with an organosilane;
forming a microemulsion of water droplets in oil;
adding the dye mixture to the microemulsion; and adding a source of silicon and a catalyst to the microemulsion, which causes growth of silica nanoparticles in the water droplets of the microemulsion which silica nanoparticles are doped with the dye.

12. A method according to claim 11, wherein the dye comprises a near infra red dye comprising 4,5-Benzo-1′-ethyl-3,3,3\3′-tetramethyl-1-(4-sulfobutyl)indodicarbocyanin-5′-acetic acid N-succinimidyl ester.

13. A method according to claim 11, wherein the dye is conjugated with an organosilane.

14. A method according to claim 11, wherein the microemulsion of water droplets in oil is formed by mixing oil, such as cyclohexane oil, and one or more surfactants, such as n-hexanol and Triton® X-100, and adding deionised water thereto.

15. A method according to claim 11, wherein the source of silicon comprises tetraethylorthosilica (TEOS) and the catalyst comprises NH₄OH.

16. A method according to claim 11, wherein the silica nanoparticles are doped with the dye by attachment of dye/organosilane conjugate of the dye mixture to the silica nanoparticles.

17. A method according to claim 11 further comprising the step of derivatising the dye-doped nanoparticles with a functional group by addition of a bioreactive organosilane to the microemulsion.

18. A method of determining a percentage weight of a dye which yields a required relative fluorescent intensity of a dye-doped nanoparticle, comprising the steps of
obtaining a measure of the radius of the nanoparticle;
determining the Forster radius of the dye;
for each of a plurality of % weights of the dye;
(i) determining the average distance between dye fluorophores in the nanoparticle;
(ii) determining the number of dye fluorophores in the nanoparticle;
(iii) determining the efficiency of Forster resonance energy transfer of the dye fluorophores using the Forster radius of the dye and the average distance between the dye fluorophores in the nanoparticle;
(iv) determining the relative fluorescent intensity of the nanoparticle using the number of dye fluorophores in the nanoparticle, the quantum efficiency of the dye and the efficiency of Forster resonance energy transfer of the dye fluorophores; and
determining the % weight of the dye which yields the required relative fluorescent intensity from the nanoparticle.

19. The method of claim 18, wherein for each of the plurality of % weights of the dye, determining the relative fluorescent intensity of the nanoparticle using the number of dye fluorophores in the nanoparticle, the quantum efficiency of the dye and the efficiency of Forster resonance energy transfer of the dye fluorophores comprises using
$$\frac{{F}_{T , n}}{{F}_{o}} = n \frac{1 - {E}_{f}}{1 - φ {E}_{f}}$$
where F_{T,n} is the total fluorescence from the excitation of the multiple dye fluorophores in the nanoparticle, F₀ is the fluorescence of a free fluorophore of the dye, n is the number of fluorophores excited and corresponds to the number of fluorophores in the nanoparticle, and Φ is the quantum efficiency of the dye.

20. A computer program product for determining a percentage weight of a dye which yields a required relative fluorescent intensity of a dye-doped nanoparticle, comprising:
an input module which receives one or parameters of the dye and the nanoparticle;
a calculation module which determines the Forster radius of the dye;
a calculation module which, for each of a plurality of % weights of the dye;
(i) determines the average distance between dye fluorophores in the nanoparticle;
(ii) determines the number of dye fluorophores in the nanoparticle;
(iii) determines the efficiency of Forster resonance energy transfer of the dye fluorophores using the Forster radius of the dye and the average distance between the dye fluorophores in the nanoparticle; and
(iv) determines the relative fluorescent intensity of the nanoparticle using the number of dye fluorophores in the nanoparticle, the quantum efficiency of the dye and the efficiency of Forster resonance energy transfer of the dye fluorophores;
a calculation module which determines the % weight of the dye which yields the required relative fluorescent intensity from the nanoparticle; and
an output module which outputs the % weight of the dye which yields the required relative fluorescent intensity from the nanoparticle.
